(19) United States
(12) Patent Application Publication
(10) Pub. No.: US 2006/0077765 A1
(43) Pub. Date: Apr. 13, 2006

(54) Super resolution information storage medium, method of making reproducing signal stable, and apparatus for recording/reproducing data on/from the super resolution information storage medium

(75) Inventors: Hyun-ki Kim, Hwaseong-si (KR); In-on Hwang, Bundang-gu (KR); Joo-ho Kim, Yongin-si (KR); Du-seop Yoon, Bundang-gu (KR)

Correspondence Address: STEIN, MCEWEN & BUI, LLP, 1400 EYE STREET, NW, SUITE 300, WASHINGTON, DC, 20005, US

(73) Assignee: SAMSUNG ELECTRONICS CO., LTD., Suwon-si (KR)

(21) Appl. No.: 11/063,725

(22) Filed: Feb. 24, 2005

(30) Foreign Application Priority Data
Feb. 25, 2004 (KR) 10-2004-0012722

(51) Int. Cl. G11B 7/24

(52) U.S. Cl. 369/13.01; 369/275.1

(57) ABSTRACT

A super resolution information storage medium, a method of making reproducing signals stable, and an apparatus for recording and/or reproducing data on a super resolution information storage medium. The information storage medium on which information is recorded as marks smaller than a resolution of an incident beam, includes a substrate, a super resolution layer formed on the substrate and generating a thermal reaction at portions where the incident beam is focused, and a phase change layer formed on or under the super resolution layer and crystallized before reproducing the recording marks.

### CROSS-REFERENCE TO RELATED APPLICATIONS

This application claims the priority of Korean Patent Application No. 2004-12722, filed on Feb. 25, 2004 in the Korean Intellectual Property Office, the disclosure of which is incorporated herein by reference.

### BACKGROUND OF THE INVENTION

1. Field of the Invention

The present invention relates to a super resolution information storage medium, a method of making reproducing signals stable, and an apparatus for recording and/or reproducing data on and/or from the super resolution information storage medium, and more particularly, to an information storage medium for reproducing information recorded as recording marks smaller than a resolution of a reproducing beam and for improving the stability of the reproduction of signals, a method of making reproducing signals stable, and an apparatus for recording and/or reproducing data on and/or from the information storage medium.

2. Description of the Related Art

An optical recording medium is used as an information storage medium for an optical pickup device for recording and reproducing information in a non-contact manner. As the information recording industry continues to develop, it is advantageous to increase the recording density of information. To this end, an information storage medium for reproducing information having recording marks smaller than the resolution of a laser beam, by using a super resolution phenomenon, is being developed.

In general, when the wavelength of a light source for reproducing information from a storage medium is λ and the numerical aperture of an object lens is NA, the limit of a reproducing resolution is λ/4NA. In other words, a beam radiated from a light source cannot distinguish recording marks smaller than λ/4NA, thus the reproduction of the information recorded with recording marks smaller than λ/4NA is impossible.

However, a super resolution phenomenon, which reproduces recording marks having a size smaller than the resolution limit, occurs, and studies of the super resolution phenomenon are being performed. According to the super resolution phenomenon, recording marks having a size smaller than the resolution limit may be reproduced, thus a super resolution storage medium can increase the density and the capacity of the storage medium.

In order to commercially use a super resolution information storage medium, recording characteristics and reproducing characteristics required as a recording medium must be satisfied. More specifically, the super resolution information storage medium uses a recording beam and a reproducing beam having higher powers than those used in a conventional information storage medium; thus, the stability of reproducing signals is an important requirement of the super resolution information storage medium.

It is important to understand the characteristics of layers of a super resolution information storage medium. A super resolution information storage medium may include a phase change layer. The recording characteristic and the reproducing characteristic of the phase change layer included in a super resolution information storage medium are different from those of a phase change layer of a conventional phase change disk.

Hereafter, a phase change recording technology will be described. A phase change disk forms recording marks as amorphous portions on a phase change recording layer to reproduce information by using reflectivity differences between crystalline portions and amorphous portions. Here, the amorphous portions become recording marks, and information is not recorded on the crystalline portions.

When recording data on the phase change recording layer, the recording layer is heated to be molten and rapidly cooled, thus the recording layer becomes amorphous and the amorphous portions become the recording marks. In addition, when erasing data from the phase change recording layer, the amorphous portions are heated to be molten and slowly cooled, thus the amorphous portions become stable crystals. In other words, the recording marks of the amorphous portions are heated to over a glass-translation temperature to be thermodynamically stable crystals. Here, a relatively higher power than a recording power is used as an erasing power.

The power of the reproducing beam used to reproduce data from a conventional phase change disk does not change the crystalline state of the recording marks, thus the crystalline state of the recording layer is not changed even after repeatedly radiating the reproducing beam and stable reproducing signals are obtained. However, the power of the reproducing beam used to reproduce data from a super resolution information storage medium is higher than that of the reproducing beam for the conventional phase change disk; thus, the phase change layer is changed when reproducing data and reproducing signals may become unstable.

### SUMMARY OF THE INVENTION

According to an aspect of the present invention, present invention provides a super resolution information storage medium for improving stability of reproducing signals by crystallizing a phase change layer before reproducing data, a method of making reproducing signals stable, and an apparatus for recording and/or reproducing data on and/or from the super resolution information storage medium.

According to an aspect of the present invention, there is provided an information storage medium for reproducing information, which is recorded as marks smaller than a resolution of an incident beam. The information storage medium comprises a substrate, a super resolution layer formed on the substrate and generating a thermal reaction at portions where the incident beam is focused, and a phase change layer formed on or under the super resolution layer and crystallized before reproducing the recording marks.

The super resolution layer may be formed of any one material selected from metal oxides formed of PtOₓ, AuOₓ, PdOₓ, and AgOₓ, or a polymer compound. A first dielectric layer may be formed between the substrate and the super resolution layer, a second dielectric layer may be formed between the super resolution layer and the phase change layer, and a third dielectric layer may be formed on the phase change layer.

A beam having a power higher than a super resolution reproducing power and lower than 150% of the super resolution reproducing power may be radiated at least once when crystallizing the phase changed layer. Recording marks may be formed in a pit type, on the substrate, or recording marks may be formed by radiating a recording beam, on the information storage medium.

According to another aspect of the present invention, there is provided a method of making reproducing signals of a super resolution information storage medium stable, the super resolution information storage medium including a substrate, a super resolution layer formed on the substrate and generating a thermal reaction at portions where the incident beam is focused, and a phase change layer formed on or under the super resolution layer to reproduce information recorded as recording marks smaller than a resolution of the incident beam, the method comprising forming recording marks on the information storage medium, and crystallizing the phase change layer before reproducing the recording marks.

According to still another aspect of the present invention, there is provided an apparatus for recording and/or reproducing data on and/or from a super resolution information storage medium, which includes a substrate, a super resolution layer formed on the substrate and generating a thermal reaction at portions where an incident beam is focused, and a phase change layer formed on or under the super resolution layer to reproduce information recorded as recording marks smaller than a resolution of the incident beam, the apparatus comprising a pickup unit radiating a beam to the information storage medium, a recording and/or reproducing signal process unit receiving the beam reflected on the information storage medium through the pickup unit and performing a signal process, and a control unit controlling the pickup unit to radiate a beam for crystallizing the phase change layer through the pickup unit at least once, before reproducing data recorded on the information storage medium.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other features and advantages of the present invention will become more apparent by describing in detail exemplary embodiments thereof with reference to the attached drawings in which:

FIG. 1 is a sectional view illustrating a super resolution information storage medium;

FIG. 2 is a sectional view illustrating a recordable information storage medium according to a first embodiment of the present invention;

FIGS. 3A through 3D illustrate RF signal levels before and after the crystallization of a phase change layer included in a super resolution information storage medium;

FIG. 4 is a sectional view illustrating a read-only super resolution information storage medium according to a second embodiment of the present invention; and

FIG. 5 is a system for recording and/or reproducing data on and/or from a super resolution information storage medium according to the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

A super resolution information storage medium according to the present invention is formed to reproduce information recorded as recording marks having a size smaller that a resolution limit of an incident beam.

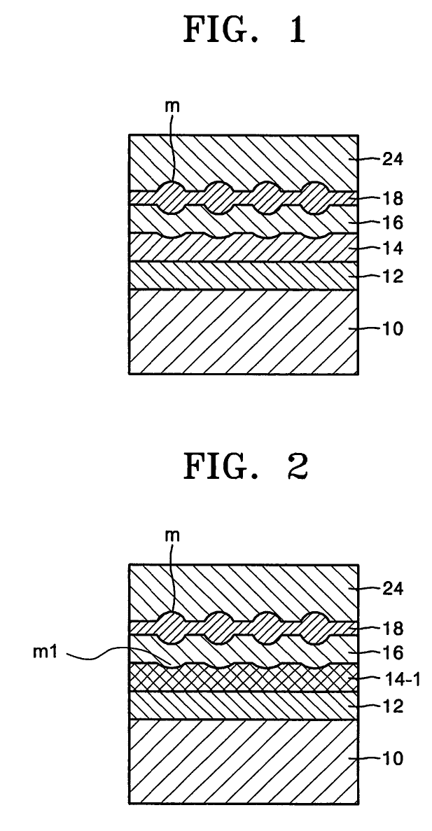

A general super resolution information storage medium will now be described with reference to FIG. 1. Referring to FIG. 1, a super resolution information storage medium includes a substrate 10, and a first dielectric layer 12, a phase change layer 14, a second dielectric layer 16, a super resolution layer 18, and a third dielectric layer 24 that are sequentially formed on the substrate 10. Here, the super resolution layer 18 thermally reacts with a recording beam or a reproducing beam.

The substrate 10 is formed of any one material selected from polycarbonate, polymethylmethacrylate (PMMA), amorphous polyolefin (APO), and glass. The super resolution layer 18 may be formed of a metal oxide or a polymer compound. For example, the super resolution layer 18 may be formed of at least one metal oxide selected from PtOₓ, PdOₓ, AuOₓ, and AgOₓ where x is a whole number. The polymer compound may be, for example, C₃₂H₁₈N₈ and H₂PC (phthalocyanine).

The phase change layer 14 may be formed of a Ge—Sb—Te-based or Ag—In—Sb—Te-based phase change material. As shown in FIG. 1, the phase change layer 14 is formed between the substrate 10 and the super resolution layer 18. Alternatively, the phase change layer 14 may be formed on the super resolution layer 18.

Processes of recording or reproducing data on or from such a super resolution layer will now be described. When radiating a recording beam to an information storage medium to record data, portions of a super resolution layer 18 to which the recording beam is radiated thermally react with the recording beam. Then, metal and oxygen are separated and oxygen bubbles are generated, thus the portions to which the recording beam is radiated become swollen. The swollen portions become recording marks m, each swollen portion m producing an indentation ml on the phase change layer 14. Here, the phase change layer 14 is thermally transformed due to the recording beam, then the thermal transformation affects the super resolution layer 18. The phase change layer 14 is transformed according to the expansion of the super resolution layer 18.

Where a reproducing beam is radiated to an information storage medium to reproduce data, plasmons having a shorter wavelength than the reproducing beam are generated from metal particles of the super resolution layer 18 to which the reproducing beam is radiated and the palsmons are excited to reproduce marks smaller than a resolution of the reproducing beam.

In order to induce thermal reactions in the super resolution layer 18 and the phase change layer 14 to record and reproduce the marks smaller than the resolution, a recording beam and a reproducing beam having a higher power than a beam used to record and/or reproduce data on and/or from a conventional information storage medium are used. Here, the conventional information storage medium denotes an information storage medium from which data is reproduced by a conventional method, other than a super resolution phenomenon.

Where the super resolution layer 18 is formed of platinum oxide, the super resolution layer 18 is separated into platinum and oxygen by radiating a laser beam. The separated platinum generates surface plasmons. A near field reproduction is possible due to the surface plasmons, thus the reproduction of signals for the recording marks smaller than the resolution of the laser beam focused on an information storage medium by an object lens is possible.

The changes in the state of the phase change layer 14 by radiating the recording beam and the reproducing beam will now be described. The phase change layer 14 is in an amorphous state right after being formed. Here, the descriptions of the changes in the state of the phase change layer 14 will be divided into a case where the phase change layer 14 is initialized, in other words, crystallized, and a case where the phase change layer 14 is not initialized.

When the phase change layer 14 is not initialized, the phase change layer 14 maintains an amorphous state. Thus, the super resolution layer 18 is thermally transformed by radiating the recording beam to such an information storage medium to form recording marks m, and the phase change layer 14 is transformed. The temperature of the phase change layer 14 is increased and rapidly lowered due to the temperature distribution of the recording beam, thus the portions of the phase change layer 14 corresponding to the recording marks m become an amorphous state.

When radiating the reproducing beam to reproduce information recorded as the recording marks m, the portions of the phase change layer 14 corresponding to the amorphous recording marks m are crystallized. The crystallizing speed of the phase change layer 14 depends on the power of the reproducing beam; however, the portions of the phase change layer 14 corresponding to the recording marks m are gradually crystallized by repeatedly radiating the reproducing beam to completely crystallize the portions corresponding to the recording marks m.

When the phase change layer 14 is initialized before recording data, the phase change layer 14 and the super resolution layer 18 are thermally transformed by radiating the recording beam to form the recording marks m. Here, the portions of the phase change layer 14 to which the recording beam is radiated are molten and rapidly cooled to become an amorphous state.

Thereafter, the amorphous portions of the phase change layer 14 corresponding to the recording marks m are crystallized by radiating the reproducing beam to reproduce the recording marks m. The amorphous portions are gradually crystallized by repeatedly radiating the reproducing beam. In addition, the reproducing signals are unstable due to the changes in reflectivity, which is changed according to the crystalline state of the phase change layer 14.

As described above, the super resolution information storage medium has a problem of generating unstable reproducing signals due to the changes in reflectivity, which is changed according to the changes in the crystalline state of the phase change layer, regardless of the initialization of the phase change layer 14. Such a problem is caused from the power of the reproducing beam used in the super resolution information storage medium that is higher than the power of the reproducing beam used in the conventional phase change disk.

Thus, in the present invention, the phase change layer is crystallized after recording data and before reproducing the data to make the crystalline state of the phase change layer uniform, in order to obtain a stable reflectivity.

FIG. 2 is a sectional view illustrating an information storage medium according to a first embodiment of the present invention. Referring to FIG. 2, an information storage medium according to the first embodiment of the present invention includes a substrate 10, a super resolution layer 18, which is formed on the substrate 10 to generate thermal reactions at portions on which incident beams are focused, and a phase change layer 14-1, which is crystallized before reproducing data. Here, the phase change layer 14-1 may be formed above or under the super resolution layer 18.

In addition, a first dielectric layer 12 may be formed between the substrate 10 and the phase change layer 14-1, a second dielectric layer 16 may be formed between the phase change layer 14-1 and the super resolution layer 18, and a third dielectric layer 24 may be formed on the super resolution layer 18.

The power of a beam, which crystallizes the phase change layer 14-1, depends on the material of the phase change layer 14-1. Here, the power of the beam is determined in a range from a power that starts the crystallization of the phase change layer 14′ to a power that starts the amorphous state of the phase change layer 14-1. It is preferable that a beam having a power higher than a super resolution reproducing power and lower than 150% of the super resolution reproducing power is radiated at least once after recording data in order to crystallize the phase change layer 14-1. When the beam of the super resolution reproducing power is radiated to crystallize the phase change layer 14-1, it is preferable that the beam is repeatedly radiated for several times. On the other than when the relatively strong beam of 150% of the super resolution reproducing power is radiated, the crystallization of the phase change layer 14-1 can be performed by radiating once.

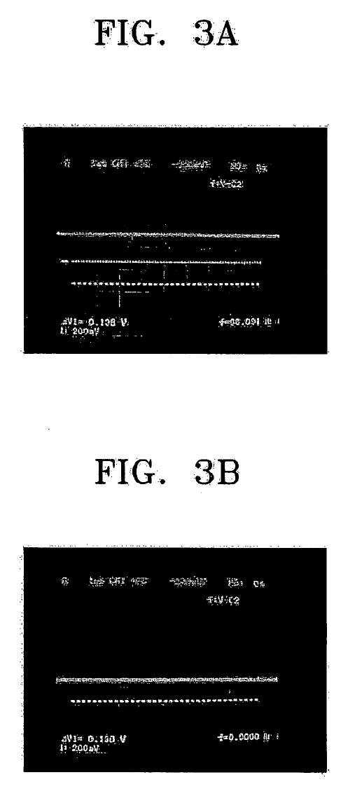

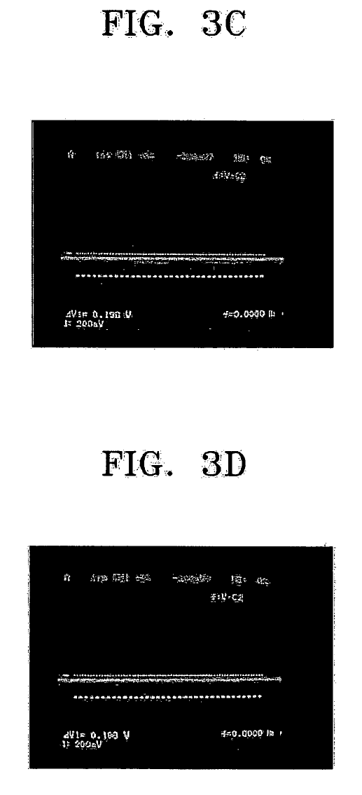

More specifically, data is recorded by controlling a linear speed to 5 m/sec, a recording power to 12 mW, and a mark length to 75 nm. When examining the state of the phase change layer 14-1 after recording, the portions to which the recording beam is radiated are in an amorphous state. FIG. 3A illustrates an RF signal level, which is obtained by reproducing using a beam of 0.5 mW after mounting a disk in a drive before recording data, and FIG. 3B illustrates an RF signal level, which is obtained by reproducing using a beam of 0.5 mW after recording data on an information storage medium. The RF signal level is changed as shown in FIG. 3B, because the crystalline state of the phase change layer is changed after the data is recorded.

FIG. 3C illustrates RF signals, which are obtained after being crystallized by radiating a beam of a super resolution reproducing power, in other words, 1.7 mW, to the portions on which the data is recorded. FIG. 3D illustrates RF signals, which are obtained by reproducing using a reproducing beam of 0.5 mW after performing a crystallization by radiating a beam of 1.7 mW for ten times. Here, FIGS. 3A and 3B are represented as comparative examples of FIGS. 3C and 3D.

Referring to FIGS. 3C and 3D, when the phase change layer is crystallized after recording data and before reproducing data, the reflectivity becomes uniform and stable RF signals are obtained.

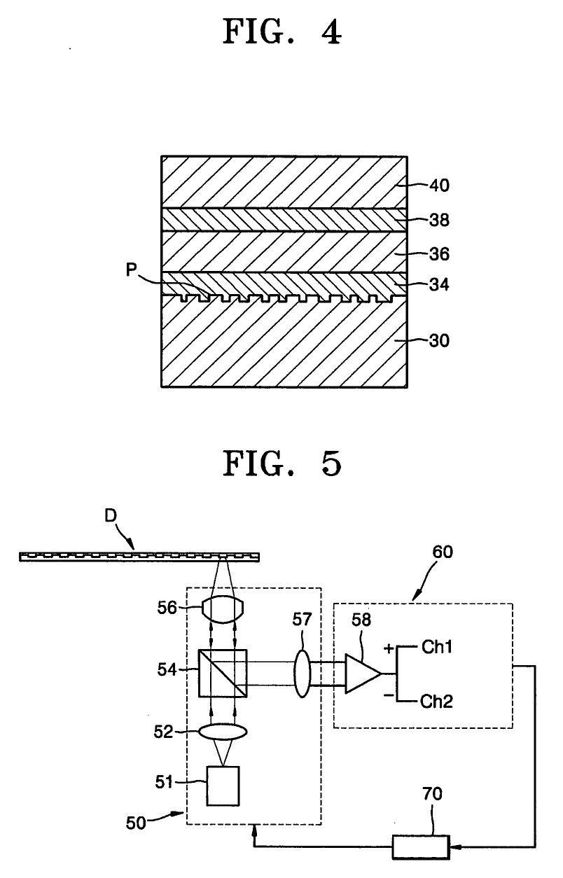

FIG. 4 is a sectional view illustrating a read-only super resolution information storage medium according to a second embodiment of the present invention. A super resolution information storage medium according to the second embodiment of the present invention includes a substrate 30, and a super resolution layer 34, a first dielectric layer 36, a phase change layer 38, and a second dielectric layer 40 that are formed on the substrate 30. Here, a dielectric layer (not shown) may be further included between the substrate 30 and the super resolution layer 34.

In the case of a read-only storage medium, recording marks are formed in a pit type P on the substrate 30. When reproducing the read-only information storage medium having pits smaller than a resolution limit of a reproducing beam, the super resolution layer 34 and the phase change layer 38 are thermally transformed by the reproducing beam to generate a super resolution phenomenon, thus data is reproduced. That is, in a read only super resolution storage medium, information is recorded in preformed pits P and then reproduced by transformations of the phase change layer 38 and the super resolution layer 34.

A characteristic of the super resolution storage medium according to the second embodiment of the present invention is that crystallization of the phase change layer 38 is performed after forming recording marks and before reproducing data. When the phase change layer 38 is crystallized before radiating the reproducing beam, the crystalline state of the phase change layer 38 is not changed even when a reproducing beam of high power is radiated, thus stable reproducing signals are obtainable.

A method of making reproducing signals stable according to the present invention includes the process of crystallizing a phase change layer after forming recording marks and before reproducing data. In this process, the power of a beam is determined based on the material of the phase change layer. Here, it is preferable that a beam higher than a super resolution reproducing power and lower than 150% of the super resolution reproducing power is radiated at least once.

In crystallizing a phase change layer, the phase change layer may be crystallized after recording data, by using one beam. In another case, the phase change layer may be crystallized by using a crystallizing beam, which is other than a recording beam, while following the recording beam.

FIG. 5 is a block diagram illustrating a system for recording and/or reproducing data on and/or from a super resolution information storage medium. A recording and/or reproducing system includes a pickup unit 50, a recording and/or reproducing signal process unit 60, and a control unit 70. More specifically, the recording and/or reproducing system includes a laser diode 51 for radiating an incident beam, a collimating lens 52 for collimating the beam radiated from the laser diode 51, a beam splitter 54 for converting the path of the incident beam, and an object lens 56 for focusing the incident beam through the beam splitter 54 on an information storage medium D.

A beam reflected from the information storage medium D is reflected by the beam splitter 54 and received by an optical detector, for example, a quad-optical detector 57. The quad-optical detector 57 converts the beam into RF signals and operation circuit 58 detects a sum signal Ch1 and a differential signal Ch2, which is a push-pull type signal.

The control unit 70 radiates a reproducing beam of higher than a predetermined power, which is determined based on the material of an information storage medium, through the pickup unit 50, in order to reproduce marks smaller than a resolution. Thus, data is recorded on the information storage medium D by the recording beam. Here, in the case of the read-only information storage medium on which recording marks are formed in a pit type, the recording process is unnecessary.

Before reproducing the data recorded on the information storage medium D, the control unit 70 radiates a beam for crystallizing a phase change layer 14-1 or 34 through the pickup unit 50, at least once. Here, the crystallization may be performed by using one laser to perform the crystallization after completing the recording or by using a recording beam and a crystallizing beam. When using two beams, the crystallizing beam follows the recording beam to perform the crystallization after recording data.

Thereafter, a reproducing beam having a power lower than the power of the recording beam is radiated to the information storage medium D through the pickup unit 50. Then, a super resolution phenomenon occurs on the information storage medium D. Here, the crystalline state of the phase change layer 14-1 or 34 is not changed, because the phase change layer 14-1 or 34 is crystallized. Accordingly, stable reproducing signals can be obtained. The super resolution phenomenon of the information storage medium D is the same as that described above, thus the descriptions thereof will be omitted.

The beam reflected from the information storage medium D is input to the optical detector 57 through the object lens 56 and the beam splitter 54. The signals input to the optical detector 57 are converted into electric signals by the operation circuit unit 58 and output as RF signals.

An information storage medium and a method of making reproducing signals stable according to the present invention prevent the changes in the crystalline state of a phase change layer due to the radiation of a reproducing beam having a relatively high power when reproducing data recorded as marks smaller than a resolution. Thus, an increased density and capacity of an information storage medium can be increased.

Here, five layers or seven layers are formed on a substrate and the material of a super resolution layer is determined in the present invention; however, those are only exemplary embodiments of the present invention.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An information storage medium for reproducing information, which is recorded as marks smaller than a resolution of an incident beam, the information storage medium comprising:
a substrate;
a super resolution layer formed on the substrate and generating a thermal reaction at portions where the incident beam is focused; and
a phase change layer formed on or under the super resolution layer and crystallized before reproducing the recording marks.

2. The information storage medium of claim 1, wherein the super resolution layer is formed of any one material selected from metal oxides formed of PtOₓ, AuOₓ, PdOₓ, and AgOₓ, or a polymer compound.

3. The information storage medium of claim 1, further comprising:
a first dielectric layer formed between the substrate and the super resolution layer,
a second dielectric layer formed between the super resolution layer and the phase change layer, and
a third dielectric layer formed on the phase change layer.

4. The information storage medium of claim 1, wherein a beam higher than a super resolution reproducing power and lower than 150% of the super resolution reproducing power is radiated at least once when crystallizing the phase changed layer.

5. The information storage medium of claim 1, wherein recording marks are formed in a pit type, on the substrate.

6. The information storage medium of claim 1, wherein recording marks are formed by radiating a recording beam on the information storage medium and the phase change layer is crystallized after radiating the recording beam and before reproducing the recording marks.

7. A method of making reproducing signals of a super resolution information storage medium stable, the super information storage system including a substrate, a super resolution layer formed on the substrate and generating a thermal reaction at portions where an incident beam is focused, and a phase change layer formed on or under the super resolution layer to reproduce information recorded as recording marks smaller than a resolution of the incident beam, the method comprising:
crystallizing the phase change layer before reproducing the recording marks.

8. The method of claim 7, wherein the super resolution layer is formed of any one material selected from metal oxides formed of PtOₓ, AuOₓ, PdOₓ, and AgOₓ, or a polymer compound.

9. The method of claim 7, wherein a first dielectric layer is formed between the substrate and the super resolution layer, a second dielectric layer is formed between the super resolution layer and the phase change layer, and a third dielectric layer is formed on the phase change layer.

10. The method of claim 7, wherein a beam higher than a super resolution reproducing power and lower than 150% of the super resolution reproducing power is radiated at least once when crystallizing the phase changed layer.

11. The method of claim 7, wherein:
the phase change layer is formed on the super resolution layer; and
the recording marks are formed in a pit type, on the substrate.

12. The method of claim 7, wherein:
the recording marks are formed by radiating a recording beam on the information storage medium, and
the phase change layer is crystallized after radiating the recording beam and before reproducing the recording marks.

13. The method of claim 7, further comprising:
forming the recording marks with a first beam, and
crystallizing the phase change layer with a second beam.

14. An apparatus for recording and/or reproducing data on and/or from a super resolution information storage medium, which includes a substrate, a super resolution layer formed on the substrate and generating a thermal reaction at portions where the incident beam is focused, and a phase change layer formed on or under the super resolution layer to reproduce information recorded as recording marks smaller than a resolution of the incident beam, the apparatus comprising:
a pickup unit radiating a beam to the information storage medium;
a recording and/or reproducing signal process unit receiving the beam reflected on the information storage medium through the pickup unit and performing a signal process; and
a control unit controlling the pickup unit to radiate a beam for crystallizing the phase change layer through the pickup unit at least once, before reproducing data recorded on the information storage medium.

15. The apparatus of claim 14, wherein the super resolution layer is formed of any one material selected from metal oxides formed of PtOₓ, AuOₓ, PdOₓ, and AgOₓ, or a polymer compound.

16. The apparatus of claim 14, wherein a first dielectric layer is formed between the substrate and the super resolution layer, a second dielectric layer is formed between the super resolution layer and the phase change layer, and a third dielectric layer is formed on the phase change layer.

17. The apparatus of claim 14, wherein a beam higher than a super resolution reproducing power and lower than 150% of the super resolution reproducing power is radiated at least once when crystallizing the phase changed layer.

18. The information storage medium of claim 1, wherein:
the phase change layer is formed on the super resolution layer; and
the recording marks are pre-formed on the substrate.

19. The information storage medium of claim 1, wherein:
the phase change layer is formed on the super resolution layer;
the recording marks smaller that the resolution of the incident beam are pre-formed on the substrate; and
other recording marks are formed on the phase change layer before crystallizing the phase change layer.

20. The method of claim 7, wherein:
the phase change layer is formed on the super resolution layer,
the recording marks smaller that the resolution of the incident beam are pre-formed on the substrate; and
the method further comprises recording other recording marks on the phase change layer before crystallizing the phase change layer.
